(19) United States
(12) Patent Application Publication
(10) Pub. No.: US 2014/0011586 A1
(43) Pub. Date: Jan. 9, 2014

(54) Social Video Sharing System Or Network

(71) Applicant: Pwnit!, Inc., Santa Monica, CA (US)

(72) Inventors: Shane Vorster, Los Angeles, CA (US); John O'Connell, Los Angeles, CA (US); Andrew Seidel, West Hollywood, CA (US)

(21) Appl. No.: 13/934,144

(22) Filed: Jul. 2, 2013

Related U.S. Application Data
(60) Provisional application No. 61/669,594, filed on Jul. 9, 2012.

(51) Int. Cl. A63F 13/12

(52) U.S. Cl. CPC A63F 13/12
USPC 463/31

(57) ABSTRACT

A computer-implemented method for providing a competitive media sharing service is described including receiving input from a user, the input including a media content, determining a user value based on the input, determining scoring in a competition that the user participates in, wherein the scoring is based on the input and the user value; and updating a profile information for the user based on the scoring.

### RELATED APPLICATIONS

This application claims benefit of priority to Provisional U.S. Patent Application No. 61/669,594, filed Jul. 9, 2012; the aforementioned priority application being hereby incorporated by reference in its entirety.

### TECHNICAL FIELD

Embodiments described herein relate to a social video sharing system or network.

### BACKGROUND

Videos sharing may be used for a number of applications. For example, shared video clips may form the basis for social discussion and gatherings.

With the advancement of technology, users may upload video clips for competitive and cooperative purposes.

### BRIEF DESCRIPTION OF THE DRAWINGS

FIG. 1 illustrates a video sharing system, according to one or more embodiments.

FIG. 2A illustrates a method for enabling a user to perform activities for obtaining health points for use in competition, according to an embodiment.

FIG. 2B and FIG. 2C illustrate examples for how health meter 133 can be implemented, according to some embodiments.

FIG. 3 illustrates a method for conducting a competition or challenge for video clip submissions on a social networking site, according to an embodiment.

FIG. 4 illustrates an interface for a challenge competition, according to an embodiment.

FIG. 5 illustrates a method for controlling a clip interface, according to an embodiment.

FIG. 6 is a block diagram that illustrates a computer system upon which embodiments described herein may be implemented.

### DETAILED DESCRIPTION

Embodiments described herein provide a social and competitive video clip submission platform. Different competitive formats can be designed to encourage viewers to submit video clips, and to partake in competitions where video clips are shared, viewed, discussed and voted on or ranked.

In variations, content other than video clips can be shared using a platform such as described by various embodiments herein. For example, content in the form of images (e.g., screenshots or photography) can be shared using any system or method described herein.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Description

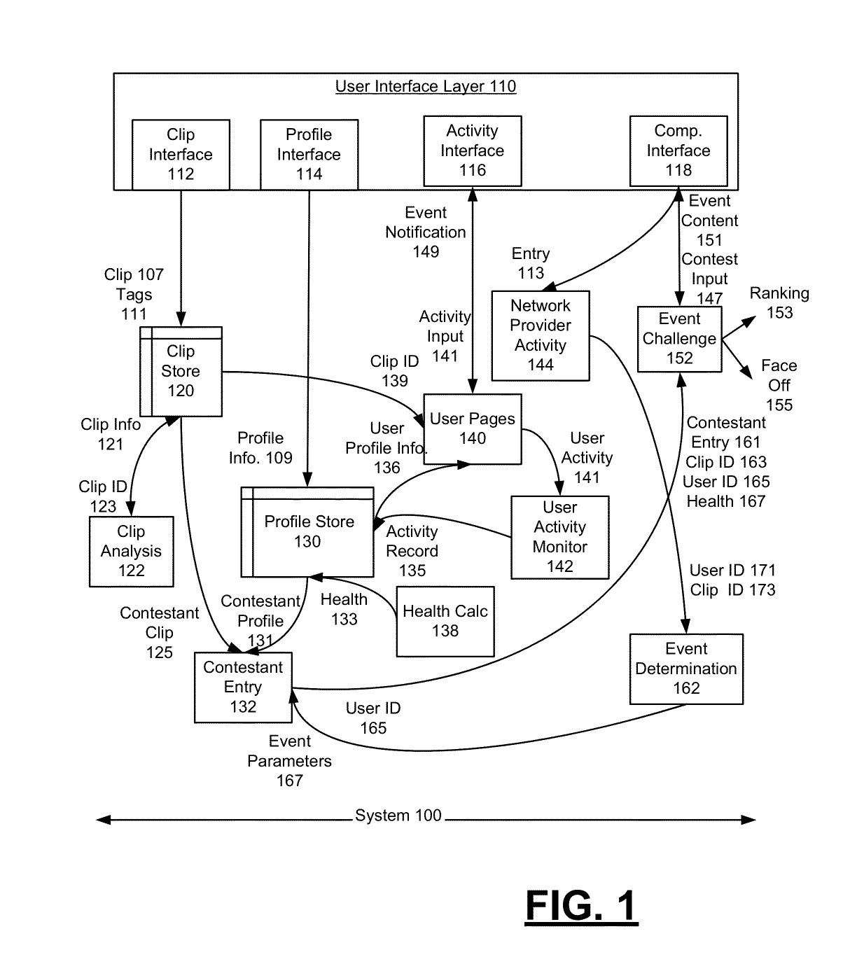

FIG. 1 illustrates a video sharing system, according to one or more embodiments. A system 10 such as shown by an embodiment of FIG. 1 can be implemented as a network service for a population of users. Among other functionality, system 10 can be implemented to enable video clip sharing in a social networking environment. More specifically, system 10 can be implemented to provide a social network for users to share video clips. In order to promote social activity and interest, network service 100 can provide competitive functionality that enables individuals to submit video clips that are judged by the user base against video clips of other users. In some implementations, competitive functionality can be provided in the context of specified themes or subjects for video clip submissions.

In some embodiments, system 10 includes a user interface layer 110, and a network service 100. The network service 100 can be implemented on one or more servers. For example, the network service 100 can be provided through a website, which a user base can access using a browser. Alternatively, the network service 100 can be made available to users operating web-based applications.

The user interface layer 110 can be implemented through processes or functionality communicated to browsers or web-based applications operating on user computing devices (e.g., personal computer or laptop, mobile computing device, tablet, etc.). The user interface layer 110 can include components for enabling users to create accounts with the network service 100, upload video clips, and partake in social networking activity. In an embodiment, a user can access profile interface 114 (e.g., such as a profile page) and provide profile information 109 to develop a user profile with the service. The user profile information 109 can be maintained on the network, using a profile store 130. The profile store 130 can correspond to a database or other data store which retains profile information from numerous users of the system 10.

The clip interface 112 enables the user to submit a video clip 107, as well as descriptive tags 111 about the clip. For example, the video clip can be for a video game sequence, or home video segment. In one implementation, clip interface 112 includes a script that executes in a browser or application of a client terminal. The clip interface 112 enables a user to upload a video clip 107 stored on the user's computing device. The clip interface 112 can also enable the user to submit descriptive tags 111 about a clip 107. For example, the user can include text with the clip 107, in the form of a label that identifies information such a subject (e.g., game title, sporting event) of what the clip 107 depicts, a location where the clip was taken, when the clip was captured, and/or other descriptive information. As a more specific example, in the context of video games, a given user can specify tags 111 that identify a sequence of events in a particular game title that is captured by a video clip 107, the name or identifier of the player, and other information such as gaming platform and time when the game sequence occurred. Other information that the user can specify with tags 111 includes labels as to what occurred (e.g., kill shot, sniper attack, escape move). In the context of home movies (e.g., sports video clips), the tags 111 can specify the sporting event, the geographic location, the persons involved (e.g., generically, like ‘Mom’, or or by name) and other descriptive information (e.g., “me my best friend kayaking down a waterfall”).

In variations, the clip interface 112 can receive other types of submissions, such as images (e.g., screenshots or photographs).

As an addition or variation, system 10 can also utilize a clip analysis component 122. The clip analysis component 122 can scan the record of each submitted clips to clip store 120 in order to augment or enhance the tags 111 provided with the individual clips. In one embodiment, the clip analysis component 120 can scan and prune user submitted tags of, for example, spelling mistakes, or errors in specifying the video game title etc. The clip analysis component 120 can also identify synonyms or alternative wording (e.g., include “kill” for “frag” etc.). As an alternative or variation, the clip analysis component 122 can perform image processing of individual frames contained within submitted clips in order to determine additional information, such as the presence of a specific class of objects. Still further, the clip analysis component 120 can scan the clips 107 for metadata (other than tags) such as the file creation date. Such additional information can be made part of the tags 111 for individual clips. Among other functions, the tags 111 can be used to enable searching or programmatic identification of clips from the clip store 120.

In some embodiments, the clip store 120 can correspond to a database or other storage medium were clips from different users are stored and associated with tags, the user's account, and other information. The clip store 120 can optionally be maintained separate from the system 10, such as by a separate entity. For example, two or more network service can share a video clip library.

The network service 100 can include components for enabling a user to maintain a profile page. Each profile page 140 can include various features, such as listing of the user submitted video clips, as well as social links between the user and other users of the network service 100 (which can alternatively be turned as “alliances” or friendships etc.). The user pages 140 can be based at least in part on profile information 136 stored in the profile store 130. In some embodiments, the user is incentivized to maintain a profile page 140, and further to specify various information and/or partake in different activities (e.g., challenges, making friends etc.). The user pages 140 can also provide clips, such as (i) clips from the user that is assigned to the particular page, (ii) clips of interest to the user (e.g., clips of others that are selected by the user) and/or (iii) clips that originate from alliances of the user.

Additionally, the user pages 140 can carry input from the user or from other users of the system 10. For example, the user interface layer 110 can include an activity interface 116 that allows a user to provide activity input 141, in the form of, for example, the user writing on his own page, send a notification to link with someone else (e.g. form an alliance) or write on someone else's user page 140 (alternately referred to as profile page 140). In order to enable rendering of clips, clip identifiers of individual clips can be included on the user pages 140 in order to enable subsequent users to render clips on the user pages 140.

In some embodiments, a user can be incentivized to maintain the profile page by way of a health meter 133, which is described in greater detail with some embodiments below. A health meter 133 can correspond to a value (e.g., health points) that can correlate to the extent that the user has performed certain activity on the network, such as activity pertaining to that user's profile page 140. For example, the health meter 133 can indicate the extent to which the user has completed fields in the profile page 140, and/or the number of alliances (or friends) the user has on the network service 100. A health calculator 138 can interface with the profile store 130 in order to determine the health meter 133 for individual users. The determination of the health meter 133 can be associated with the user account (e.g., via profile store 130). The health meter 133 can be displayed on the user pages 140, and also utilized in the competitive environment when users submit video clips for competition.

As described herein, the system 10 can include various processes or components for implementing competitive functionality. According to one or more embodiments, competitive functionality can be implemented in a network service 100 using components such as contestant entry 132, event challenge 152, and event determination 162. Event determination 162 represents functionality for determining parameters for an event challenge. The event challenge 152 includes functionality for conducting a competition based on clip submissions. Additionally, the user interface layer 110 includes features or additional interfaces for enabling the user to participate, either as spectator or competitor, in the competitive events.

In more detail, the event determination 162 includes one or more processes that provide for functionality, including defining parameters for competitive event, and determining when and for how long the competitive event is to take place. The event parameters 167 can include, for example, topical designations, relating to the context or subject of corresponding video clips. For example, in the context of video clips for videogame sequences, the event parameters can specify (i) the game title, (ii) the platform, and (iii) the type of occurrence that is depicted in the video clips (e.g., “Best kill shot for Call of Duty”). For home sporting movies, the event parameters can specify, for example, (i) the type of sporting event, (ii) the geographic location, and/or (iii) a date range. More generally, the event parameters can simply specify a question or statement that is to be fulfilled by user submission of video clips. For example, the event parameters can correspond to designation: “playing video game while being called to dinner.” The event determination 162 can include functionality to determine the event parameters 167 from user submissions or from polling.

Contestants for competitive events can be programmatically or manually selected. In one embodiment, once the parameters of the competitive event are determined, event parameters 167 can be used to programmatically determine contestants. In one implementation, contestant entry 132 includes processes to scan and select video clips 107 from the clip store 120, based on tags 111 associated with individual clips. The contestant entry 132 can identify individual contestant entries 161, each of which included clip identifier 163, and a user identifier 165. In embodiments in which health parameter 133 is utilized, the contestant entry 161 can also specify the health of the individual contestant (e.g., by user ID).

In variations, the event parameters can be communicated to users of the network service 100 through activity component 144. The activity component 144 can announce or send notifications to users of the event competitions. Users can respond by enlisting in the announced competition as a competitor, or by, for example, accessing the service at a time of the announcement to participant in the competition as a spectator or voter. For example, in one implementation, the user interface player 110 includes a competition interface 118. A user can respond to an event notification or communication 149 by specifying an entry 113. The entry 113 can designate an existing video clip previously submitted by the user, or a newly submitted clip that the user provides in response to the event notification 149. The activity component 144 can correlate the entry 113 to the user and provide communication to the event determination 162 that includes a user identifier 171, and a clip identifier 107.

The event challenge 152 can implement different forms of competitions to gauge opinion from the users. Event challenge 152 can include functionality for implementing a competition based on a set of rules. Specific examples of competitions include rankings 153 and or face-offs 155. In an example, the rankings 153 can be implemented as part of a ladder system or ladder tournament. Ranking rules, for example, can provide for listing contestant entries 161 based on a score, or listing contestants by some other metric. Scoring can reflect the number of votes a video clip receives, or alternatively a compilation of ranking scores a video clip receives from multiple users. In the latter case, for example, clips can be rated from scores of 1 to 5, and the score can reflect the average or cumulative total of points received by users.

Event challenge 152 can also implement a set of rules for providing a face-off 155, or alternatively a series of face-offs, such as in a tournament fashion. Under a face-off, a set of two or more clips 107 are pitted against one another. The users of the system 10 can vote as to which clip in the set that user prefers. The voting can determine scoring, and consequently the winner. The winning clip can then be paired against another clip (e.g., such as another winning clip). An eventual winning clip can be identified from a series of challenges.

The event challenge 152 may be issued from varied sources. In an example, an event challenge 152 may be issued by a user to another user, without being part of a formal tournament. In another example, event challenge 152 is part of an organized tournament. As such, in examples the event challenge 152 may be provided as part of user-generated and/or part of a user opt-in formats.

The rules governing event challenge 152 may include numerous different kinds of rules, such as: a requirement that the event challenge 152 must involve clips 107 of a same game, that the clips 107 in event challenge 152 must align with the context of the clip being challenged, that the clips 107 may be of any video game, or that only a particular number of players may participate in the challenge (e.g. 1v1). Other examples of rules include settings which are specific to a clip and set by a user. For example, a user may set a clip to: (i) only receive challenges from players or clips meeting a minimum score requirement, (ii) only accept challenges from clips having required tags, and/or (iii) only accept challenges from players or clips having similar view counts.

Some embodiments provide that with any of the competitive events described, the health meter 133 can weight or influence scoring. For example, in one embodiment, the health meter 133 can add a baseline score to each score. Thus, a user with a higher health meter 133 can be provided an advantage in competition.

The event challenge 152 can communicate event content 151 to the user interface player 110. The competition interface 118 can enable the individual user to, for example, participate in the competitions by, for example, viewing clips and voting. The event challenge 152 can record contest inputs 147 submitted by individual users through the competition interface 118. Some specific examples of how competitions can be conducted are provided in more detail below.

In some embodiments, the user activity monitor 142 can monitor input submitted to the event challenge 152 when a competitions taking place. The activity monitor 142 can note a particular user's participation in a particular competition. User participation and competition can also influence the user's health parameter 133, as determined by the health calculator 138.

Methodology

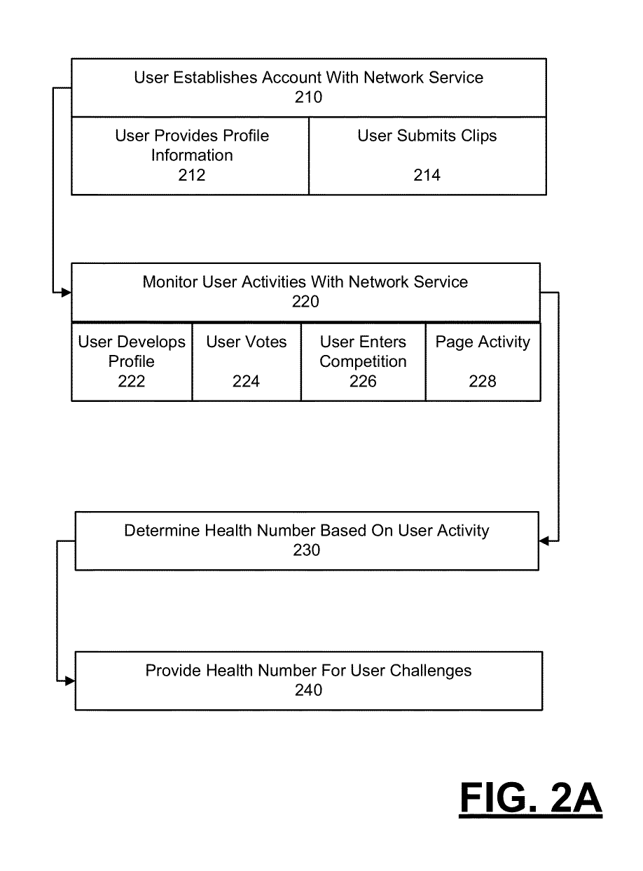

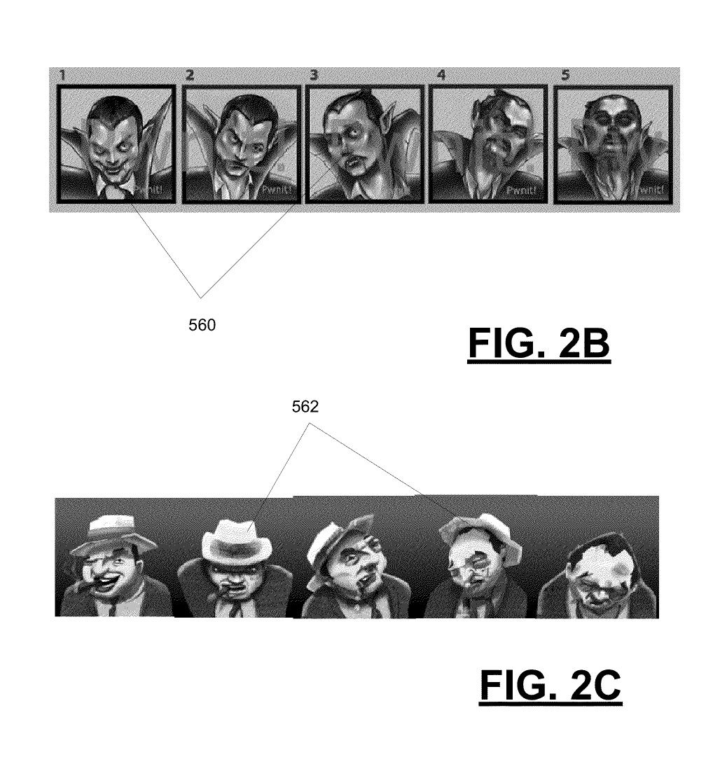

FIG. 2A illustrates a method for enabling a user to perform activities for health, according to an embodiment. A method such as described by an embodiment of FIG. 2A can be implemented using, for example, a system such as described with FIG. 1. Accordingly, reference may be made to elements of system 10 for purpose of illustrating suitable components for performing a step or sub step being described.

With reference to FIG. 2A, a user establishes an account with a network service (210). The user can interact with components of the user interface layer 110 in order to provide the information for establishing the account and the associated profile information. For example, the user may register, and submit password and login information, as well as creating an online avatar or persona. The user can also provide profile information, such as the gender, age, and preferences. Once the user has established his account, he can submit video clips of his videogame sequences, and/or home movies of the sporting events (214).

Once the user begins participating, his activities on the network service can be detected or monitored (220). For example, the user activity monitor 142 can be used to monitor user activity on the network. The purpose of the activity monitoring can be to determine the health meter, or other scoring, such as the user's credentials. Specific examples of activities that can be monitored include (i) the user develops his profile, (e.g., extensively), (222) (ii) user participates as a spectator in the competitions (e.g., votes), (224) (iii) user participates in a competition as a competitor (e.g., submits a clip) (226), and/or (iv) page activities (e.g., messaging, placing messages on other user pages etc.) (228).

According to some embodiments, the user's health meter can be determined based on the user's activities (230). In one implementation, the health calculator 138 can determine health meter 133 based on one or more kinds of user activity. For example, the health meter 133 can be determined based on an extent of user activity. Some user activities can be associated with a greater number of health points as compared to other activities. In variations, the user can be penalized by health points for not performing certain activities. Numerous such variations can be developed based on the design implementation of, for example, system 10.

In some embodiments, the health number 133 is used to facilitate scoring during competition (240). For example, in some embodiments, a value can be associated with a user's health meter, and the value can translate to a life score that can be adjusted based on user voting during the competition.

In some variations, each user can create an avatar, which can include an image of the user's online persona. The health meter 133 can affect the appearance of the avatar. As an addition or alternative, a competition score (e.g., life meter, present during competition) can affect the appearance of the avatar. For example, the avatar can be bloodied, or depicted with a black eye during competition based on the score/health received during the competition.

FIG. 2B and FIG. 2C illustrate examples for how health meter 133 can be implemented, according to some embodiments. FIG. 2B and FIG. 2C each illustrate examples of avatars, which a user can select or configure. In FIG. 2A, the example avatar 260 is Dracula, and in FIG. 2C, the example avatar 262 is a “tough guy” wearing a hat. As an example, users sign-up and complete basic registration requirements to threshold of 100 points (which is not equivalent to 100%). Users can increase their health by doing actions using the service. For example, the user can increase his health to a maximum of 200 point. The health can be communicated visually as a bar and can correlate to the health of the avatar image. For example, FIG. 2B and FIG. 2C illustrate the respective avatars being hurt with reduction in health during competition. In some implementations, when the health is reduced by a designated increment, some injury or damage can be reflected in the avatar. For example, the avatars 560, 562 can receive a black eye, bloody nose, or have a hat knocked off.

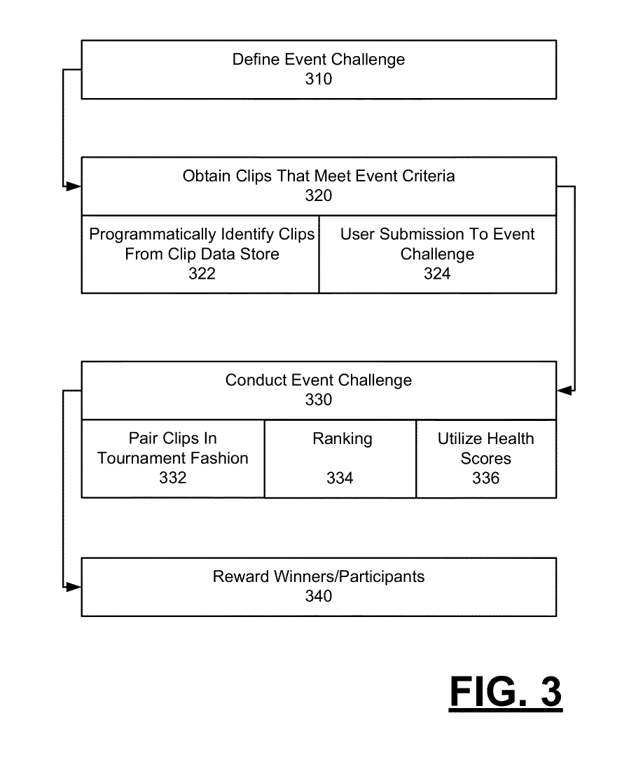

FIG. 3 illustrates a method for conducting a competition or challenge for video clip submissions on a social networking site, according to an embodiment. A method such as described by an embodiment of FIG. 3 can be implemented using, for example, a system such as described with FIG. 1. Accordingly, reference may be made to elements of system 10 for purpose of illustrating suitable components for performing a step or sub step being described.

In FIG. 3, an event challenge is defined (310). The event challenge can include parameters that dictate requirements of a video clip, such as timing, location, length, subject (e.g., video game title, platform, sporting event) and other parameters (e.g., self-captured, with Mom in background, etc. The event challenge can be determined from, for example, polling (e.g., providing user's choices, and using top choice for event challenge), user submissions, or administrator input.

Once the event challenge is defined, clips that meet the criteria of the event challenge can be obtained (320). Clip identification can be done programmatically, for example, by components scanning tags of clips to select individual clips that meet the parameters of the competition (322). In variations, the clip identification can be done manually through, either administrator input, or user input (324). For example, a user can respond to a challenge by submitting a video clip, or specifying an existing clip from the data store.

Once contestants of an event challenge are identified, the event challenge can be conducted (330). Multiple competitive formats can be utilized. Clips can be paired in tournament fashion (332). As an alternative or variation, clips that meet the selection criteria can be ranked (334). In one implementation, a qualification round is conducted to determine a set of highest ranked clips from all clips that are in the competitive field. For example, the highest eight clips can be identified from a field of 100. The ranking in the qualification round can be based on, for example, viewers liking a clip, ranking it with a rating score (e.g., three star), and/or viewing it. Once the qualifying round is conducted, the tournament challenge can be performed. For example, the top eight video clips can be paired so that there are four separate contests. In each pairing, users can vote for one clip over the other. After a given duration of time (e.g., a day or an hour), the winner is determined based at least in part on votes received. The winners of each round are paired until there is one winner.

In variations, a staging period can be allotted between the qualifying round and the head-to-head competition. During the staging period, the administrator can validate the entrants (e.g., preview the submitted clips to ensure proper subject). The competitors can use the staging period to rally ally votes. Still further, in some variations, spectators can be encouraged to make predictions as to the winners of the individual competitions. The success of spectators in predicting winners in competition can be tracked. Spectators can be rewarded (e.g., receive health meter, prize) based on participating in predictions or having success in their ability to make predictions.

In some embodiments, the heath meter of individual users is determined for purpose of competition (336). The health meter can affect the user's score in one or more of the competitive formats. For example, on the qualifying stage (if such stage is held), the health meter can be added to the user's score, so that user's with higher health meters can receive added score boosts. As another example, during pairing or challenge competition, users can have a life meter that reflects (i) their votes as compared to the other user, and/or (ii) their health. If the life meter dwindles, for example, the user's avatar can depict injury or damage. Eventually, one user can win the challenge. The person's life meter can be carried over to the next round, with or without boost, so that, for example, the easy victor will receive an advantage. Alternatively, the health and life meters can restart with each new contest in the tournament challenge.

The winner of a given competition can be rewarded with a prize (340). For example, the winner can receive a gift certificate, a coupon, cash, prize, privileges, health units (e.g., addition to health meter 133) etc.

In embodiments, each spectator vote for a particular video clip can be treated as, for example, a “like” for the selected video clip. Accordingly, a user's vote for a particular video clip can be published to a social network, optionally with the clip the user voted on, and any other metrics or message (e.g., “User A voted for this video and it has received 2000 votes. Vote now . . . ”). In implementation, correlating a social networking “like” action to a vote can have additional significance. In particular, a feature such as a social networking “like” action can serve as a vote when used with a system such as described herein, signifying that the user is picking one video clip over another. The user can also use the vote/like optional to signify choice and a prediction as to a winner. In variations, a user's record as to predicting wins/losses can correlate to social currency or credibility. Numerous such variations or possible as to how a vote can be communicated to various social networking platforms and environments.

Numerous variations can be provided in the manner in which competitions are scored, either with or without use of health. For example, an embodiment includes provisions for all voting. An ally can correspond to a friend or person who is linked (or designated as ally or friend) on, for example, a social network or environment in which competition is held. A user can be encouraged to obtain allies or friends by, for example, rewarding competition votes from allies more so than non-allied. Thus, in competition, two competitors can be matched, and the competition can utilize a tally that is based at least in part on votes, as well as, with additional bonus provided from votes from allies.

In another implementation, a custom counter can be utilized for counting Ally (Friend) Votes. Such votes can reward an opportunity to directly apply Health Damage (e.g., detract from the opponents health) during competition. In implementation, when an Ally vote occurs, an extra vote or point can be rewarded. The user who has the ally can elect to use extra votes to damage a health of an opponent during competition. For example, one implementation provides for the user to select to activate an Ally Vote during competition.

The value and application of the Ally Vote can be based on design implementation. For example, multiplier for the Ally Vote can be changed. For example, each vote can add 0.25, so every 4 Ally Votes give a User +1 Regular Vote. A user can apply their Ally meter (or cumulative Ally votes) and negatively impact the other user. For example, the All Vote can be truncated (e.g., 4.5=4) and then translated into regular votes (e.g., 1:1 correlation) against an opponent. One applied, the Ally Vote meter can be depleted. As an example, a User A can have 4.5 Ally Votes, and elect to apply the Ally Votes during competition. A value of −4 Health is applied to the opponent User B. Then the User A's Ally meter resets to 0.0.

The meter can be visually represented to participants and/or spectators. For example, in one implementation, each Ally Vote can represent 0.25 regular votes, and can be exchanged for regular votes in increments of 1.0. As an example, a triangular representation can be used in which each of three sides represents a fraction of the number of all votes (0.25, 0.50. 0.75). Every fourth vote can trigger a +1 integer in a counter (e.g., which can be provided in the center of the triangle).

Ally voting or an ally meter may be used to determine rankings 153. For example, in a ladder tournament, the number of ally votes may be a factor used to determine rankings 153 to rank a user on the ladder. In another example, ally voting is used in a head-to-head matchup to determine rankings 153.

Video Clip Sharing Challenge

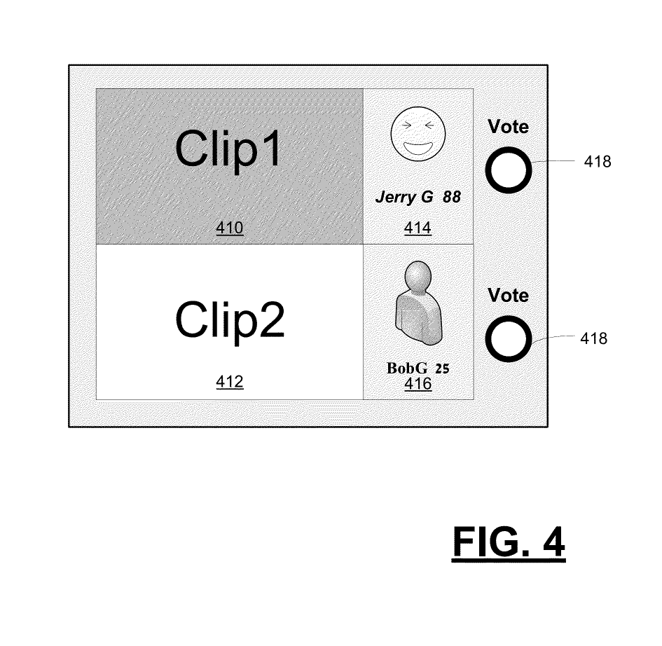

FIG. 4 illustrates an interface for a challenge competition, according to an embodiment. An interface 400 can be provided through, for example, user interface layer 110 (see FIG. 1). For example, competition interface 118 (see FIG. 1) can present an interface 410 to enable users of the system 10 to participate in the competitive events. In the example provided by FIG. 4, the competitive event is a face-off, in which two (or potentially more) clips are subjected to users for voting, with one winner being determined by votes and optionally health.

In the example provided, the interface 400 includes a first clip 412 submitted by a first user 414 and a second clip 412 submitted by a second user 416. Each user can be represented by a respective avatar. The avatar can reflect an image selected by the user, and optionally health or life based on the outcome of the competitive event. For example, in a close competition, both avatars can become bloodied or bruised. Users can vote on one clip over another. The voting can be a basis for determining the victor, as can other metrics (e.g., health, life meter etc.).

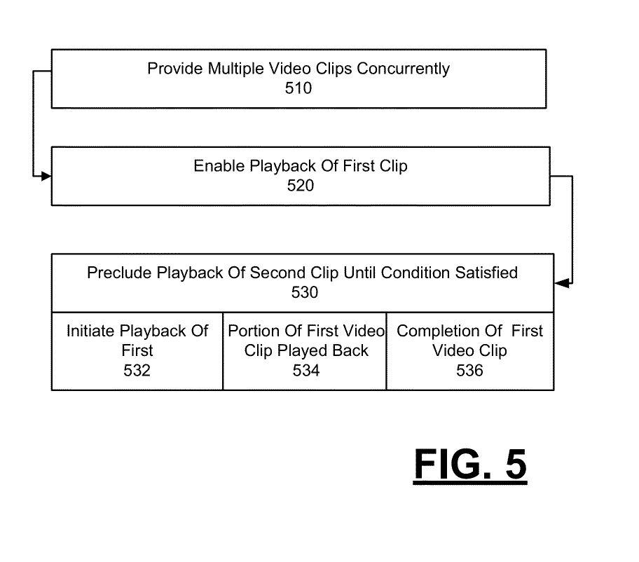

FIG. 5 illustrates a method for controlling a clip interface, according to an embodiment. A method such as described by FIG. 5 can be used to control an interface such as depicted with FIG. 4. For example, clip interface 400 can be controlled in a competitive environment (E.g., face-off o video clips), using a method such as described with FIG. 5.

In an embodiment, multiple video clips are provided concurrently through a single interface (510). For example, a window can display two clips at one time. One clip can be enabled for playback (520), while the other clip is controlled in a manner that precludes playback until a predetermined condition is satisfied. In examples provided, the condition can correspond to playback of the first clip being initiated (532). As an alternative, the condition can correspond to a portion of the playback of the first video clip being completed (534). For example, the second clip may be enabled if 5 seconds of playback have occurred with the first video playback. As still another alternative, the second clip may only be enabled if the first video clip is completely played back (536).

In variations, other conditions can be specified for enabling the second clip to be played back. For example, if the viewer watches a designated portion of the first video clip and votes against the clip, playback of the second video clip can be enabled.

A method of FIG. 5 can be repeated for additional video clips. For example, a third clip can be enabled for playback if certain conditions are met with regard to playback of the first video clip and/or playback of the second video clip.

While numerous embodiments described herein provide for users to submit video clips, in variations, other kinds of files or resources can be submitted. For example, numerous embodiments described herein can be equally applicable to other types of content, such as images (e.g., user photography), audio files, and/or documents. Thus, for example, one or more embodiments can provide for a competitive social environment for sharing photography or other content (e.g., poetry, music etc.).

Computer System

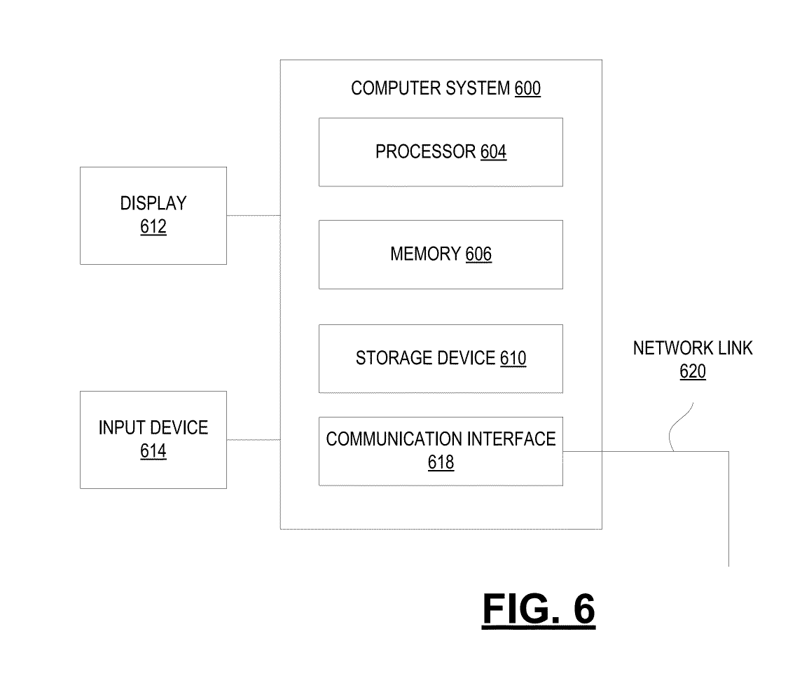

FIG. 6 is a block diagram that illustrates a computer system upon which embodiments described herein may be implemented. For example, in the context of FIG. 2, system 100 may be implemented using one or more computer systems such as described by FIG. 6.

In an embodiment, computer system 600 includes processor 604, memory 606 (including non-transitory memory), storage device 610, and communication interface 618. Computer system 600 includes at least one processor 604 for processing information. Computer system 600 also includes a main memory 606, such as a random access memory (RAM) or other dynamic storage device, for storing information and instructions to be executed by processor 604. Main memory 606 also may be used for storing temporary variables or other intermediate information during execution of instructions to be executed by processor 604. Computer system 600 may also include a read only memory (ROM) or other static storage device for storing static information and instructions for processor 604. A storage device 610, such as a magnetic disk or optical disk, is provided for storing information and instructions. The communication interface 618 may enable the computer system 600 to communicate with one or more networks through use of the network link 620 (wireless or wireline).

Computer system 600 can include display 612, such as a cathode ray tube (CRT), a LCD monitor, and a television set, for displaying information to a user. An input device 614, including alphanumeric and other keys, is coupled to computer system 600 for communicating information and command selections to processor 604. Other non-limiting, illustrative examples of input device 614 include a mouse, a trackball, or cursor direction keys for communicating direction information and command selections to processor 604 and for controlling cursor movement on display 612. While only one input device 614 is depicted in FIG. 6, embodiments may include any number of input devices 614 coupled to computer system 600.

Embodiments described herein are related to the use of computer system 600 for implementing the techniques described herein. According to one embodiment, those techniques are performed by computer system 600 in response to processor 604 executing one or more sequences of one or more instructions contained in main memory 606. Such instructions may be read into main memory 606 from another machine-readable medium, such as storage device 610. Execution of the sequences of instructions contained in main memory 606 causes processor 604 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computer-implemented method for providing a competitive media sharing service, comprising:
using one or more processors to perform steps including:
receiving input from a user, the input including a media content;
determining a user value based on the input;
determining scoring in a competition that the user participates in, wherein the scoring is based on the input and the user value; and
updating a profile information for the user based on the scoring.

2. The method of claim 1 wherein the scoring includes ranking the received media against a set of competitor media content.

3. The method of claim 1 wherein the profile information includes the user value.

4. The method of claim 3, wherein updating a profile information for the user based on the scoring includes, in response to the user winning the competition, providing a prize to the user.

5. The method of claim 1 wherein the scoring is based on voting by other users of the media sharing service.

6. The method of claim 1 wherein the profile information includes an avatar image, and wherein updating profile information includes updating the avatar image based on the scoring.
